(19) United States
(12) Patent Application Publication
(10) Pub. No.: US 2022/0235302 A1
(43) Pub. Date: Jul. 28, 2022

(54) COMPOSITION AND METHOD FOR MAKING DISTILLED SPIRIT

(71) Applicant: BROTHER JUSTUS WHISKEY CO., Minneapolis, MN (US)

(72) Inventor: Philip Joseph Steger, St. Paul, MN (US)

(21) Appl. No.: 17/613,623

(22) PCT Filed: May 29, 2020
(86) PCT No.: PCT/US20/35182

§ 371 Date: Nov. 23, 2021

Related U.S. Application Data
(60) Provisional application No. 62/855,159, filed on May 31, 2019.

(51) Int. Cl. C12G 3/07; C12H 6/02; C12H 1/22

(52) U.S. Cl. CPC C12G 3/07; C12H 1/22; C12H 6/02

(57) ABSTRACT

A method for making a distilled spirit includes distilling a liquor comprising alcohol to form a distilled liquor; and contacting the distilled liquor with peat. The peat may include peat dry matter. The peat may include dried peat. The peat may include partially charred peat. The peat may include 50 wt-% or less of inorganic carbon on a dry weight basis. The peat may be arranged in a filter cartridge. The distilled liquor may be contacted with the peat for at least 5 seconds. A composition includes distilled liquor comprising alcohol and water; and peat. The peat may include peat dry matter. The peat may include dried peat. The peat may include partially charred peat. The peat may include 50 wt-% or less of inorganic carbon on a dry weight basis. The composition may include 40 vol-% or more of alcohol based on liquid components of the composition.

### FIELD

The present disclosure relates to a composition and method for making a distilled spirit.

### BACKGROUND

A typical process for making whiskey includes malting grains (usually barley) by hydrating the grains with water and then allowing the grains to partially germinate to activate enzymes naturally present in the grains. In addition to barley, other grains may also be used or added, such as wheat, rye, or corn. The grains may be malted or not malted. After a few days of germination, the grains are dried at low heat to stop germination, while preserving the enzymes. In some cases, the grains are flavored using smoke from a fire during drying. In particular, traditional Scottish Highland and Islay whiskeys may be flavored by peat smoke generated by adding peat to the fire during drying of the malted grain. Thus, the term “peaty” or “peated” traditionally refers to a smoky flavor profile due to smoke from the fire that has peat added to it.

The dried malt is usually milled and then mashed by mixing with hot water and allowing the enzymes to convert starches into sugars. The remaining grains may be removed from the process liquid known as wort. The wort is cooled and mixed with yeast to initiate fermentation. Fermentation is allowed to progress until a desired alcohol level is reached, ranging at the low end from 6-8 vol-% to as high as 18-20 vol-% depending on the yeast and fermentation conditions.

The fermented liquor is distilled to purify and concentrate the alcohol, as well as to refine and concentrate the flavors. The liquor is typically distilled to a strength of about 65-70 vol-%, but may be distilled to a strength as high as of about 85-90 vol-%, and afterwards adjusted down to cask strength (typically between 58 vol-% and 62 vol-%) by adding water. The liquor is then brought to contact with oak (or other wood) and may be aged in casks anywhere from a few months to several years, turning the distilled liquor into whiskey. Traditionally, oak casks or barrels are used for aging. The inside surface of the cask may be charred.

### SUMMARY

A method for making a distilled spirit includes distilling a liquor comprising alcohol to form a distilled liquor; and contacting the distilled liquor with peat. The peat may include peat dry matter. The peat may include dried peat. The peat may include partially charred peat. The peat may include 50 wt-% or less of inorganic carbon on a dry weight basis. The peat may be arranged in a filter cartridge. The distilled liquor may be contacted with the peat for at least 5 seconds.

A composition includes distilled liquor comprising alcohol and water; and peat. The peat may include peat dry matter. The peat may include dried peat. The peat may include partially charred peat. The peat may include 50 wt-% or less of inorganic carbon on a dry weight basis. The composition may include 40 vol-% or more of alcohol based on liquid components of the composition.

### DETAILED DESCRIPTION

The present disclosure relates to a composition and method for making a distilled spirit. The present disclosure further relates to a composition and method for making distilled alcoholic beverage from malted or non-malted grain or other crops. In particular, the present disclosure relates to a composition and method for preparing a distilled alcoholic beverage with a peat flavor, and more particularly, a whiskey with peat flavor.

The term “peat” is used in this disclosure to describe a material harvested from a peatland, mire, or bog, that includes incompletely decomposed organic plant material (humus), such as reeds and sedges and to such harvested material that has been treated or processed, for example by heating, provided that the treated or processed peat retains peat flavor.

The term “peat flavor” is used here to describe a flavor profile that includes at least some components of peat. For example, the flavor profile may include certain resins, sterols, fatty acids, hydroxy acids, alkanes, long-chain alcohols, phenolic acids, and terpenoids typically found in peat. The peat flavor produced by the methods of the present disclosure is distinguished from a traditional “peaty” or “peated” flavor which is distinctly smoky due to the use of smoke from a fire to which peat has been added.

The term “inorganic carbon” is used in this disclosure to describe elemental carbon (e.g., graphite and carbon black) and various inorganic carbon species. Inorganic carbon may be the product of carbonization. Activated carbon and charcoal are understood to contain high amounts of inorganic carbon, such as 50 wt-% or greater or 75 wt-% or greater.

The term “hardness” is used in this disclosure to refer to a material's ability to resist attrition during handling and operation. Hardness may be given as a “hardness number” and determined by the Ball-Pan Hardness test. In the Ball-Pan Hardness test, a certain amount of material is put into a pan, together with some steel balls, and shaken for a defined period of time. The material is weighed before and after the shaking to determine the amount of attrition. The percent of original material that remains after shaking is the “hardness number.” ASTM D3802-16 Standard Test Method for Ball-Pan Hardness of Activated Carbon, which is directed to activated carbon, may be modified and employed to test hardness of peat granules.

The term “alcohol” is used in this disclosure to refer to ethyl alcohol (ethanol) unless otherwise stated.

The term “alcohol-extracted peat compound” is used in this disclosure to refer to a compound that is transferred from peat to a solvent in contact with the peat, where the solvent includes alcohol. Preferably, the alcohol-extracted peat compound is extracted from the peat by contacting the peat with distilled liquor. The distilled liquor may have an alcohol concentration of 50 vol-% or greater, 60 vol-% or greater, 70 vol-% or greater, or 80 vol-% or greater. Preferably, the peat is in solid form, such as dried granulated peat.

The term “substantially” as used here has the same meaning as “significantly,” and can be understood to modify the term that follows by at least about 75%, at least about 90%, at least about 95%, or at least about 98%. The term “not substantially” as used here has the same meaning as “not significantly,” and can be understood to have the inverse meaning of “substantially,” i.e., modifying the term that follows by not more than 25%, not more than 10%, not more than 5%, or not more than 2%.

The term “about” is used here in conjunction with numeric values to include normal variations in measurements as expected by persons skilled in the art, and is understood have the same meaning as “approximately” and to cover a typical margin of error, such as ±5% of the stated value.

Terms such as “a,” “an,” and “the” are not intended to refer to only a singular entity but include the general class of which a specific example may be used for illustration.

The terms “a,” “an,” and “the” are used interchangeably with the term “at least one.” The phrases “at least one of” and “comprises at least one of” followed by a list refers to any one of the items in the list and any combination of two or more items in the list.

As used here, the term “or” is generally employed in its usual sense including “and/or” unless the content clearly dictates otherwise. The term “and/or” means one or all of the listed elements or a combination of any two or more of the listed elements.

The recitations of numerical ranges by endpoints include all numbers subsumed within that range (e.g., 1 to 5 includes 1, 1.5, 2, 2.75, 3, 3.80, 4, 5, etc. or 10 or less includes 10, 9.4, 7.6, 5, 4.3, 2.9, 1.62, 0.3, etc.). Where a range of values is “up to” or “at least” a particular value, that value is included within the range.

The words “preferred” and “preferably” refer to embodiments that may afford certain benefits, under certain circumstances. However, other embodiments may also be preferred, under the same or other circumstances. Furthermore, the recitation of one or more preferred embodiments does not imply that other embodiments are not useful and is not intended to exclude other embodiments from the scope of the disclosure, including the claims.

Embodiments of the present disclosure relate to methods of preparing a distilled spirit or alcoholic beverage suitable for human consumption. According to some embodiments, the distilled spirit is prepared by fermentation of a grain or other crop to produce a fermented liquor containing alcohol, and by distilling the fermented liquor. Distillation may be used to concentrate the alcohol in the liquor. Distillation may also be used to remove undesired fractions and/or to concentrate desired flavor compounds.

The crop used to prepare the fermented liquor may include any suitable grain or mixture of grains. Suitable grains may include barley, wheat, rye, oat, corn, sorghum, rice, etc., and combinations thereof. Other starch- or sugar-containing plant materials may also be used, such as potatoes, grapes, sugarcane, sugar beets, agave, etc. In some embodiments the grain includes barley. The grain may be malted or non-malted or may include a mixture of malted and non-malted grains.

According to an embodiment, a distilled liquor or distilled spirit is prepared by distilling a fermented liquor containing alcohol. The distilled liquor may be contacted with peat to impart a peat flavor to the distilled liquor. In some embodiments, the distilled liquor is whiskey. In other embodiments, the distilled liquor includes gin, vodka, brandy, or the like. Further, in some embodiments the distilled liquor is a whiskey with peat flavor, a gin with peat flavor, a vodka with peat flavor, or a brandy with peat flavor.

Any suitable peat material may be used in the method. Peat sourced from different geographical locations may exhibit different botanical, hydrological, and mineral properties and may impart a different flavor profile. The peat used in the method may be selected to result in a desired flavor profile. For example, peat from a temperate or continental climate peatland, such as those found in the U.S. Midwest (e.g., Minnesota), may be used.

The peat may include peat dry matter. For example, the peat may include dried, compressed, pelletized, granulated, ground, or otherwise suitably processed peat. The peat may be processed using methods disclosed in U.S. Pat. No. 8,232,225 to Green et al., incorporated here in its entirety. The peat may include peat granules with a hardness of about 50% to about 100%, or from about 75% to about 100%. Using peat granules treated to have sufficient hardness (e.g., 50% or greater or 75% or greater) may be beneficial for processing the distilled liquor. In some embodiments, the peat is processed so that the peat does not substantially dissolve in the distilled liquor. In some embodiments, the peat includes peat dried at a high heat, such as at temperatures ranging from 200° F. (about 93° C.) to about 1000° F. (about 540° C.). The peat may be dried using a temperature profile that includes a combination of lower temperatures (e.g., 180° F. to 300° F.) and higher temperatures (e.g., 800° F. to 900° F.). During one or more of the process steps (for example, during exposure to higher temperatures ranging from 500° F. to 900° F.) the peat may be exposed to a low-oxygen environment. For example, the peat may be exposed to a stream of an inert gas, such as carbon dioxide or nitrogen. The peat may include partially charred peat. However, in at least some embodiments, the peat contains 5 wt-% or less, 10 wt-% or less, 25 wt-% or less, or 50 wt-% or less of inorganic carbon (e.g., carbonized carbon due to charring) on a dry weight basis. In some embodiments, the peat is raw (untreated) peat or minimally treated peat. Minimal treatment may include, for example, filtration to remove water, compression, drying at a low (e.g., 300° F. or lower) temperature, particle size reduction, or a combination thereof. The peat dry matter may have a moisture content of 70 wt-% or less, 50 wt-% or less, 35 wt0% or less, 25 wt-% or less, 20 wt-% or less, or 15 wt-% or less prior to being contacted with the distilled liquor. In some embodiments, the peat has a moisture content of 1 wt-% or more, 2 wt-% or more, 5 wt-% or more, 10 wt-% or more, 20 wt-% or more, or 30 wt-% or more prior to being contacted with the distilled liquor. The peat may also be treated to modify the flavor profile of the peat, for example, by selectively removing or reducing the amount of one or more flavor compounds found in raw peat. Examples of peat flavor compounds that may be modified, removed, reduced, or enhanced include certain resins, sterols, fatty acids, hydroxy acids, alkanes, long-chain alcohols, phenolic acids, and terpenoids typically found in peat.

The distilled liquor may be contacted with peat in any suitable manner. For example, the peat may be dispersed in the distilled liquor, or the distilled liquor may be flown (e.g., filtered) through the peat. In some embodiments the peat is arranged in a filter cartridge, and the distilled liquor is passed through the peat within the filter cartridge.

The distilled liquor may be contacted with the peat for 1 second or longer, 2 seconds or longer, 5 seconds or longer, 10 seconds or longer, 15 seconds or longer, 30 seconds or longer, 1 minute or longer, 10 minutes, 30 minutes or longer, 1 hour or longer, 6 hours or longer, 12 hours or longer, 24 hours or longer, 48 hours (2 days) or longer, 3 days or longer, 4 days or longer, or 1 week or longer. The distilled liquor may be contacted with the peat for up to several weeks, such as for 4 weeks or less, 3 weeks or less, or 2 weeks or less. The distilled liquor may be contacted with the peat for 48 hours or less, 24 hours or less, 12 hours or less, 6 hours or less, 2 hours or less, 1 hour or less, 30 min or less, 10 min or less, 5 min or less, 3 min or less, 2 min or less, or 1 min or less. The distilled liquor may be contacted with the peat for 1 second to 1 hour. The distilled liquor may be contacted with the peat for 10 seconds to 30 minutes. The distilled liquor may be contacted with the peat for 30 seconds to 10 minutes. The distilled liquor may be contacted with the peat for 1 day to 3 weeks. The distilled liquor may be contacted with the peat for 4 days to 20 days. The distilled liquor may be contacted with the peat for 1 week to 2 weeks. In some embodiments, a majority of the peat is removed from the distilled liquor after contacting the distilled liquor with the peat. In particular, the peat dry matter may be separated from the distilled liquor after contacting the distilled liquor with the peat. However, some peat components may remain in the distilled liquor, such as certain peat flavor compounds. The peat components that remain in the distilled liquor may be referred to as the alcohol-extracted peat compounds. Examples of peat flavor compounds may include certain resins, sterols, fatty acids, hydroxy acids, alkanes, long-chain alcohols, phenolic acids, and terpenoids typically found in peat. In one embodiment, the distilled liquor is contacted with peat for 3 days or longer (such as 1 to 2 weeks) and the contacted distilled liquor comprises one or more peat flavor compounds selected from resins, sterols, fatty acids, hydroxy acids, alkanes, long-chain alcohols, phenolic acids, and terpenoids. In one embodiment, the distilled liquor is contacted with peat for 24 hours or longer (such as up to 4 weeks) and the contacted distilled liquor comprises one or more peat flavor compounds selected from resins, sterols, fatty acids, hydroxy acids, alkanes, long-chain alcohols, phenolic acids, and terpenoids. In one embodiment, the distilled liquor is contacted with peat for 10 seconds to 30 minutes and the contacted distilled liquor comprises one or more peat flavor compounds selected from resins, sterols, fatty acids, hydroxy acids, alkanes, long-chain alcohols, phenolic acids, and terpenoids.

The distilled liquor may be contacted with any suitable amount of peat to achieve a desired flavor profile. For example, the distilled liquor may be contacted with the peat at a ratio of 0.5 w/v-% or greater, 0.75 w/v-% or greater, 1.0 w/v-% or greater, 1.5 w/v-% or greater, or 2 w/v-% or greater of peat to distilled liquor. The distilled liquor may be contacted with the peat at a ratio of 5 w/v-% or less, 4 w/v-% or less, 3.5 w/v-% or less, or 3 w/v-% or less of peat to distilled liquor. In some embodiments, the distilled liquor is contacted with the peat at a ratio of 0.75 w/v-% to 3.5 w/v-%, or 1 w/v-% to 3 w/v-% of peat to distilled liquor.

After distillation and prior to contacting with peat, the distilled liquor may have an alcohol concentration of 50 vol-% or greater, 60 vol-% or greater, 70 vol-% or greater, or 80 vol-% or greater. In some cases, the fermented liquor is distilled to an alcohol concentration of about 90 vol-%. The distilled liquor may be mixed with water prior to contacting with peat to result in an alcohol concentration of 75 vol-% or less, 70 vol-% or less, 65 vol-% or less, or 60 vol-% or less. The distilled liquor may be mixed with water prior to contacting with peat to result in an alcohol concentration of 40 vol-% or greater, 45 vol-% or greater, 50 vol-% or greater, or 55 vol-% or greater. In one embodiment, the distilled liquor has an alcohol concentration of about 55 vol-% to about 65 vol-%, or about 58 vol-% to about 62 vol-% when contacted with peat.

The method may further include aging the distilled liquor. In some embodiments, it is desired that the distilled liquor is in contact with wood during aging. This may conveniently be achieved by aging the distilled liquor in a wood cask or barrel. At least part of the inside surface of the wood cask or barrel may be charred. In some embodiments, the aging is performed prior to contacting the distilled liquor with the peat. The distilled liquor may be mixed with water prior to aging to result in an alcohol concentration 75 vol-% or less, 70 vol-% or less, 65 vol-% or less, or 60 vol-% or less. The distilled liquor may be mixed with water prior to aging to result in an alcohol concentration 40 vol-% or greater, 45 vol-% or greater, 50 vol-% or greater, or 55 vol-% or greater. In one embodiment, the distilled liquor has an alcohol concentration of about 55 vol-% to about 65 vol-%, or about 58 vol-% to about 62 vol-% during aging. The aged distilled liquor (e.g., whiskey or other spirit) may be contacted with peat without further dilution with water. However, after having been contacted with peat, the aged distilled liquor (e.g., whiskey or other spirit) may be diluted with water to a desired alcohol content, such as about 35 vol-% to about 70 vol-%, 35 vol-% to about 60 vol-%, 35 vol-% to about 55 vol-%, or about 38 vol-% to about 50 vol-%.

According to an embodiment, the distilled liquor, which includes at least alcohol and water, is mixed with peat. Thus, a composition is formed that is a mixture of distilled liquor and peat. The peat may include peat dry matter. The peat may include partially charred peat. However, the peat may include 5 wt-% or less, 10 wt-% or less, 25 wt-% or less, or 50 wt-% or less of inorganic carbon on a dry weight basis. The composition may include 40 vol-% or more of alcohol based on liquid components of the composition (for example, excluding peat dry matter). After a desired contact time (e.g., as discussed above), the peat may be removed, while leaving at least some flavor components in the distilled liquor. The peat may be removed, for example, by filtration, centrifugation, or any other suitable separation method. According to an embodiment, a distilled spirit includes a distilled liquor and an alcohol-extracted peat compound. The alcohol-extracted peat compound may include desired flavor components of the peat.

### EXAMPLES

### Example 1

The effect of filtering distilled liquor, prior to aging, through peat on the flavor profile of the resulting whiskey was evaluated.

Malted barley was ground and mashed by mixing with hot water. The grains were removed from the process liquid to prepare wort. The wort was cooled and fermented with yeast. The fermented liquor was distilled to about 90 vol-% of alcohol. The distillate was mixed with water to achieve 59.55 vol-% alcohol. The diluted distillate was filtered through a bed of granulated dried peat (prepared according to methods disclosed in U.S. Pat. No. 8,232,225) placed in a coffee filter. About 30 g of the granulated dried peat was used to filter about 475 mL of diluted distillate. The filtration rate was approximately 475 mL per 10 minutes, or about 48 mL/min. The temperature of the distillate was 70° F.

According to a sensory test of the filtered distillate, the resulting spirit had a delicate earthy, oily, herbal aroma and flavor. No smokiness was detected.

The filtered distillate was then added to a newly charred oak barrel of approximately 6.2 gallons volume. This filtered distillate was allowed to age for 4 months. The batch was diluted with water to 45 vol-% and bottled, and was again sensory tested.

Particulate matter was observed to have settled in each bottle, with clear whiskey above a cloudy, milky layer. Sensory testing found a normal flavor profile from the oak as expected. The fruity flavor profile from the peat was less pronounced after aging and the overall flavor profile was found to be close to a baseline (a non-peat-filtered whiskey).

### Example 2

Distillate was filtered as described in Example 1, except that the alcohol content of the distillate was adjusted to 54.95 vol-% (sample 1) and 55.55 vol-% (sample 2) prior to filtering.

The sensory results of samples 1 and 2 prior to aging in an oak barrel were similar to Example 1. Sample 1 was aged in an oak barrel with char level of “standard 4,” and sample 2 was aged in an oak barrel with char level of “standard 5,” a heavier char level.

Sensory testing revealed a darker color and a more pronounced roast flavor in each sample as compared to Example 1. The sensory test found that the peaty flavors carried over more but were also transformed in the barrel into new flavor profiles. The flavor descriptors used by the sensory panel included wet fur, cardboard, and phenolic flavors.

### Example 3

The effect of filtering aged whiskey through peat on the flavor profile of the whiskey was evaluated.

A distilled liquor was prepared as described in Example 1. The distilled liquor was adjusted with water to 60.05 vol-% alcohol and aged in an oak barrel for approximately 170 days. A filter bed was prepared by applying 100 g of granulated dried peat into a 3-foot tall stainless-steel tube.

The whiskey was filtered through the filter bed twice at a rate of about 1 gal per 10 minutes, or about 380 mL/min. The alcohol content of the filtered whiskey was adjusted to 43 vol-% prior to conducting a sensory analysis.

The sensory test found that the whiskey exhibited a normal organoleptic profile associated with a whiskey. In addition, flavors of the peat were noticeable and identifiable. The resulting whiskey had earthy, herbal, grassy, and floral profiles of peat, without smoky notes.

The filtered whiskey was bottled in 750 mL glass bottles and allowed to rest for 2-3 weeks. After resting, the whiskey retained its flavor profile. Some precipitate and a cloudy layer were found to have accumulated at the bottom of the bottle. However, clear whiskey could be decanted off the top into another bottle. The decanted whiskey did not develop a precipitate.

### Example 4

The effect of different moisture contents and levels of drying of the peat on the flavor profile of the whiskey was evaluated. Five different types of peat were obtained, prepared in ways to result in different moisture contents as shown in TABLE 1 below. All of the peat samples were harvested from Aitkin County, Minn.

The processing methods included low-temperature oven drying at 170° F. for 6 hours (samples 1, 2, and 3), screening, rehydration, filter pressing, (samples 2, 3, and 4) drying in a rotary drum heater at 350° F. (sample 3 and 4), and the methods disclosed in U.S. Pat. No. 8,232,225 (sample 5).

TABLE 1
Peat samples.

| Sample number | Peat type/moisture content |
|---|---|
| 1 | Raw peat |
| 2 | Peat filter cake, 64% moisture |
| 3 | Dried peat pellets, 35% moisture |
| 4 | Dried peat pellets, 12% moisture |
| 5 | Granulated dried peat, 6% moisture |

0.3 g of each peat sample was soaked in 1.0 oz (about 30 mL) of 62.1 vol-% ethanol for two weeks. The samples, including the flavor profile imparted by the peat, were evaluated at the end of two weeks.

It was observed that raw peat left a large amount of haze and floating particulate matter in the ethanol. The amount of haze and particulate matter was gradually less for more processed peat samples, being almost absent from sample number 5. It was further observed that samples 1-4 imparted certain sulfurous flavor notes to the ethanol, with the raw peat (sample number 1) resulting in the most pronounced sulfur flavor. Sample number 5 did not impart significant flavors to the ethanol, including no unpleasant sulfur flavor.

### Example 5

The effect of the amount of peat and the duration of immersion were evaluated on the resulting flavor profile.

Granulated dried peat was immersed in aged whiskey (43 vol-% alcohol). The amount of peat varied from 1 g/dL (grams per deciliter) to 3 g/dL. 750 mL of whiskey was combined with the peat and placed in an Erlenmeyer flask. The samples were stirred for the first 8 hours, then rested for 16 hours. Aliquots of the samples were drawn at 24 hours for flavor profiling. The samples were further allowed to proceed for another four days, including 8 hours of stirring and 16 hours of resting each day. The samples were decanted using a pipette, and the flavor profiles of the samples were evaluated. The results are shown in TABLE 2 below.

TABLE 2
Flavor profiles.

| Amount of peat | Flavor profile, Day 1 | Flavor profile, Day 5 |
|---|---|---|
| 1 g/dL | Mild floral | Floral, earthy, herbal |
| 2 g/dL | Mild floral, fruity | Floral, earthy, herbal, |
| | | slightly spicy, maple |
| 3 g/dL | Mild floral, fruity | Floral, earthy, herbal, |
| | and sweet | spicy, maple, mesquite, |
| | | hickory |

It was observed that both increased amount of peat and increased immersion time added more flavors to the resulting whiskey.

### Example 6

The effect of the duration of immersion was evaluated on the resulting flavor profile.

Granulated dried peat (1 g/dL) was immersed in aged whiskey (43 vol-% alcohol). Samples were stirred or shaken approximately every other day. Aliquots of the samples were drawn for flavor profiling at 1 week, 2 weeks, and 3 weeks. The results are shown in TABLE 3 below.

TABLE 3
Flavor profiles, amount of peat 1 g/dL.

| Time | Flavor profile |
|---|---|
| 1 week | Very mild effects, slight floral notes |
| 2 weeks | More pronounced effects, floral, earthy, and herbal |
| 3 weeks | Floral, earthy, and herbal, increased musty flavor |

All references and publications cited herein are expressly incorporated herein by reference in their entirety into this disclosure, except to the extent they may directly contradict this disclosure. Although specific embodiments have been illustrated and described herein, it will be appreciated by those of ordinary skill in the art that a variety of alternate and/or equivalent implementations can be substituted for the specific embodiments shown and described without departing from the scope of the present disclosure. It should be understood that this disclosure is not intended to be unduly limited by the illustrative embodiments and examples set forth herein and that such examples and embodiments are presented by way of example only with the scope of the disclosure intended to be limited only by the claims set forth here.

1. A method for making a distilled spirit, the method comprising:
distilling a liquor comprising alcohol to form a distilled liquor; and
contacting the distilled liquor with peat.

2. The method of claim 1, wherein the peat comprises peat dry matter.

3. The method of claim 1, wherein the peat comprises dried peat.

4. The method of claim 1, wherein the peat comprises partially charred peat.

5. The method of claim 1, wherein the peat comprises 5 wt-% or less, 10 wt-% or less, 25 wt-% or less, or 50 wt-% or less, preferably 25 wt-% or less, most preferably 10 wt-% or less, of inorganic carbon on a dry weight basis.

6. The method of claim 1, wherein the peat dry matter has a moisture content of 25 wt-% or less, 20 wt-% or less, or 15 wt-% or less prior to being contacted with the distilled liquor.

7. The method of claim 1, wherein the peat is arranged in a filter cartridge.

8. The method of claim 1, wherein the distilled liquor is contacted with the peat for 1 second or longer, 2 seconds or longer, 5 seconds or longer, 10 seconds or longer, 15 seconds or longer, 30 seconds or longer, 1 minute or longer, 10 minutes, 30 minutes or longer, 1 hour or longer, 6 hours or longer, 12 hours or longer, 24 hours or longer, 48 hours (2 days) or longer, 3 days or longer, 4 days or longer, or 1 week or longer; and for 48 hours or less, 24 hours or less, 12 hours or less, 6 hours or less, 2 hours or less, 1 hour or less, 30 min or less, 10 min or less, 5 min or less, 3 min or less, 2 min or less, or 1 min or less; preferably for 1 second to 1 hour or 5 seconds to 30 minutes, most preferably for 10 seconds to 10 minutes.

9. The method of claim 1, further comprising separating at least a majority of the peat from the distilled liquor.

10. The method of claim 1, wherein the peat comprises peat dry matter, the method further comprising separating the peat dry matter from the distilled liquor.

11. The method of claim 1, further comprising aging the distilled liquor.

12. The method of claim 1, wherein the distilled liquor is in contact with wood during aging.

13. The method of claim 1, wherein the aging occurs prior to contacting the distilled liquor with peat.

14. The method of claim 1, wherein the distilled liquor comprises alcohol at a concentration of 50 vol-% or greater, 60 vol-% or greater, 70 vol-% or greater, or 80 vol-% or greater.

15. The method of claim 1, wherein the distilled liquor is mixed with water prior to contacting with peat to result in an alcohol concentration of 40 vol-% or greater, 45 vol-% or greater, 50 vol-% or greater, or 55 vol-% or greater, or from 40 vol-% to 65 vol-%, 55 vol-% to 65 vol-%, or 58 vol-% to 62 vol-%.

16. The method of claim 1, wherein the distilled spirit is a beverage suitable for human consumption, preferably wherein the distilled spirit comprises one or more peat flavor compounds selected from resins, sterols, fatty acids, hydroxy acids, alkanes, long-chain alcohols, phenolic acids, and terpenoids.

17. A composition comprising:
distilled liquor comprising alcohol and water; and
peat.

18. The composition of claim 17, wherein the peat comprises peat dry matter.

19. The composition of claim 17, wherein the peat comprises partially charred peat.

20. The composition of claim 17, wherein the peat comprises 5 wt-% or less, 10 wt-% or less, 25 wt-% or less, or 50 wt-% or less, preferably 25 wt-% or less, most preferably 10 wt-% or less, of inorganic carbon on a dry weight basis.

21. The composition of claim 17, wherein the composition comprises 40 vol-% or greater, 45 vol-% or greater, 50 vol-% or greater, or 55 vol-% or greater, or from 40 vol-% to 65 vol-%, 55 vol-% to 65 vol-%, or 58 vol-% to 62 vol-%.

22. A distilled spirit made with the method of claim 1.

23. (canceled)
